(19) United States
(12) Patent Application Publication
(10) Pub. No.: US 2021/0206114 A1
(43) Pub. Date: Jul. 8, 2021

(54) COLOR MAPPING RESOURCES FOR FUSING AGENTS AND COLORANTS

(71) Applicant: HEWLETT-PACKARD DEVELOPMENT COMPANY, L.P., Spring, TX (US)

(72) Inventors: Morgan T. SCHRAMM, Vancouver, WA (US); Matthew A. SHEPHERD, Vancouver, WA (US); Vanessa VERZWYVELT, Vancouver, WA (US); David M. BERFANGER, Vancouver, WA (US); Jake WRIGHT, San Diego, CA (US); Hector LEBRON, San Diego, CA (US); Andrew E. FITZHUGH, Polo Alto, CA (US)

(73) Assignee: HEWLETT-PACKARD DEVELOPMENT COMPANY, L.P., Houston, TX (US)

(21) Appl. No.: 16/075,606

(22) PCT Filed: Jul. 10, 2017
(86) PCT No.: PCT/US2017/041327

§ 371 Date: Aug. 4, 2018

(51) Int. Cl. B29C 64/393; B33Y 50/02; G05B 19/4099

(52) U.S. Cl. CPC B29C 64/393; B33Y 50/02; G05B 2219/49023; G05B 2219/35134; G05B 19/4099

(57) ABSTRACT

In an example, a method includes determining an additive manufacturing process instruction, the additive manufacturing process instruction comprising an instruction specifying a coverage of a set of print agents comprising a fusing agent and a colorant to be applied to build material. A color and a behavioural property of carrying out an additive manufacturing process according to the additive manufacturing process instruction may be determined and, in response to a determination that the behavioural property meets predetermined parameters, the instruction and the color may be added to a color mapping resource.

### BACKGROUND

Three-dimensional (3D) printing is an additive manufacturing process in which successive layers of material are laid down to form three-dimensional objects from a data model. In additive manufacturing, successive material layers may be joined together by fusing, binding, or solidification through processes including sintering, extrusion, and irradiation. The quality, appearance, strength, and functionality of objects produced by such systems can vary depending on the type of additive manufacturing technology used.

### BRIEF DESCRIPTION OF DRAWINGS

Non-limiting examples will now be described with reference to the accompanying drawings, in which:

FIG. 1 is an example of a method of determining a color mapping resource for additive manufacturing;

FIGS. 2 and 3 are examples of apparatus for processing data relating to additive manufacturing; and

FIG. 4 is an example of a machine readable medium in association with a processor.

### DETAILED DESCRIPTION

Additive manufacturing techniques may generate a three-dimensional object through the solidification of a build material. In some examples, the layer of build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber.

Additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

In some examples, selective solidification is achieved through directional application of energy, for example using a laser or electron beam which results in solidification of build material where the directional energy is applied. In other examples, at least one print agent may be selectively applied to the build material, and may be liquid when applied.

Print agents may comprise fusing agents, colorants, property modification agents (e.g. colorants, conductive agents, agents to promote transparency and the like), fusing inhibiting agents and the like, some examples of which are discussed below.

For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a layer of the three-dimensional object in accordance with the pattern.

There may be different types of fusing agents. For example, a fusing agent may be based on carbon, and have a dark or black color. Lighter colored, or low tint' fusing agents may have alternative thermally absorbent compositions such as a Cesium Tungsten Oxide (CWO) or Cesium Tungsten Bronze (CTB) composition. Such low tint fusing agents may be designed to absorb energy in the infrared spectrum, and may be substantially clear or transparent in the visible portion of the spectrum. A low tint fusing agent may have a relatively light color, for example a light cyan, can be combined with other colorants to produce a broad gamut of colors (which may be broader than that for combinations including carbon black fusing agent).

In some examples, a print agent may comprise a fusion inhibiting agent (also referred to as a modifying or detailing agents). Such agents may for example cool build material (for example through evaporation), and may include water, an alcohol, a glycol or the like (for example ethanol, ethylene glycol, glycerin/glycerol, and/or propylene glycol). In other examples, a fusion inhibiting agent may be chemically formulated so as to prevent fusion.

A property modification agent, for example comprising a colorant, a conductive agent, an agent to provide transparency or elasticity or the like, may in some examples be used to provide a particular property for the object. For example, a colorant (e.g. a dye or pigment) may in some examples be used as a print agent to provide a particular color for the object.

Thus, print agents for additive manufacturing may be broadly categorized as either thermal modulators (fusing agents such as carbon based or low tint fusing agent, and fusion inhibiting agents), or property modulators, which may comprise color modulators (e.g. cyan, magenta, yellow, cosmetic black or other colors). The thermal modulators are largely responsible for the extent of fusing and may be selected at least primarily for mechanical properties, and thermal control during object generation during the build. The color modulators are used primarily for color.

While such classification of the agents set out a primary purpose of the print agents, in practice, however, thermal modulators contribute to the color appearance of the finished part (for example, it may be difficult to provide bright colors if carbon black is used as a fusing agent and/or low tint fusing agent may impact the appearance of a mix of colorants), and property modulators such as color modulators contribute to the local thermal properties, as they may absorb or reflect at least some radiation—in practice, color modulators tend to absorb radiation resulting in heating. Indeed, in some examples, color modulators may function to cause fusing in the absence of any dedicated fusing agent. In some examples, the energy applied to a layer in such a case may be increased compared to an example in which a dedicated fusing agent is used.

Note that a distinction may be made between cosmetic black and carbon black in some examples. Cosmetic black agents may be selected for providing a particular color, or a wide color gamut, whereas carbon black fusing agents may be selected primarily for their absorption characteristics in the near infrared wavelength range. However, in some examples, this could comprise a single agent. However, as noted above, irradiation of a cosmetic black agent may result in some heating.

Examples set out herein take into account both the coloring and contribution to fusion of all print agents, and may relate to a color mapping resource (for example, a color look-up table) which may be used to produce objects having a wide color gamut.

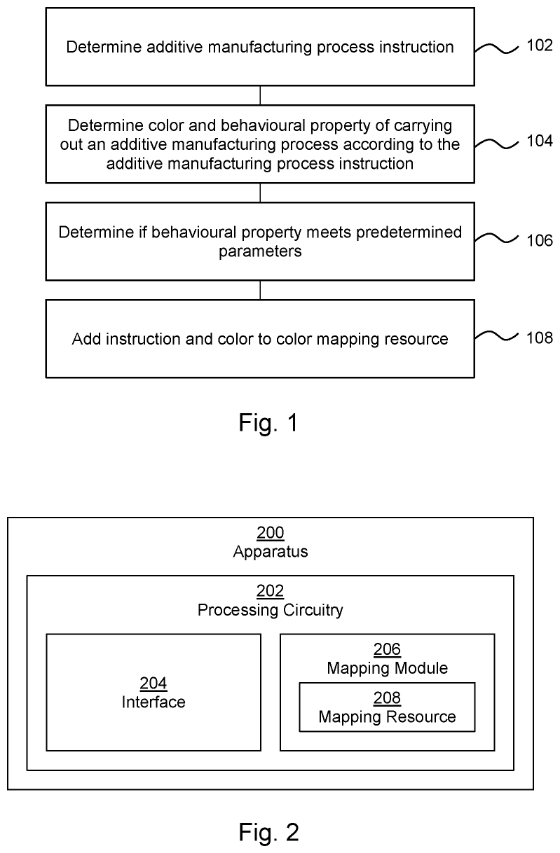

FIG. 1 shows an example of a method of determining a color mapping resource for additive manufacturing.

Block 102 comprises determining an additive manufacturing process instruction. The additive manufacturing process instruction comprises an instruction specifying a coverage of a set of print agents comprising a fusing agent and a colorant to be applied to build material. As noted above, a fusing agent is a print agent which is selected to act primarily as a thermal modulator and a colorant is a print agent which is selected to act primarily as a color modulator. The instruction may comprise an instruction to print at least one print agent in each of these two categories, according to specified proportions. In some examples, the set of print agents may comprise a plurality of fusing agents associated with different behavioural properties and/or colors (e.g. a carbon black based fusing agent and a low tint fusing agent), and/or a fusion inhibiting agent. In other examples, the set of print agents may comprise other property modulators such as conductive agents. The colorant may comprise organic pigment, inorganic pigment, organic dye, thermochromic dye such as leuco dye, or the like. The colorant may be selected so as to access a color space of colors for an object to be formed. For example, the colorant may form part of a four color model, such as CYMK (cyan, magenta, yellow, and black (key)) model.

The instruction may be specified in terms of a coverage vector, for example specifying that X % of a region of a layer of build material is to have a particular fusing agent applied thereto, Y % is to have a particular colorant applied thereto and Z % is to be left clear, i.e. devoid of print agent. In such examples, X and Y may total more than 100% as agents may be overlaid in locations. In other examples, the proportional coverage of a defined combination of print agents may be specified. In other examples, the instruction may be specified in terms of the amount of a print agent to be applied to a unit volume of build material.

Block 104 comprises determining a color and a behavioural property of carrying out an additive manufacturing process according to the additive manufacturing process instructions. In some examples, this may comprise generating a test object according to the instructions and measuring the color and the behavioural property. For example a colorimeter may be used to determine the color and the behavioural property may be measured using apparatus depending on which property of the test object is to be assessed. In other examples, this may comprise modelling the anticipated color and behavioural property or interpolating the anticipated color and behavioural property from a previously generated object.

Block 106 comprises determining if the behavioural property meets predetermined parameters (e.g. threshold parameters, such as strength, fusion completion threshold, fusion inhibition, and the like) and, if so, in block 108, the instruction and the color are added to a color mapping resource.

The behavioural property may for example comprise a mechanical behaviour of fused build material obtained from carrying out the print instruction: for example, did/will the intended portion of a layer of build material fuse? In some examples, this may be determined using a thermal or visual camera. In some examples, the method may comprise determining that a behavioural property meets a predetermined threshold and/or that target threshold is achieved: for example, is an object formed according to the print instruction associated with at least a threshold object strength, or an intended elasticity or the like. In some examples, the intended property may be associated with a tolerance. Such behavioural properties may be determined by making measurements of the generated object.

In some examples, the behavioural property comprises a thermal behaviour (which may be determined using a thermal camera or the like). For example, does the temperature reach a fusing temperature (or stay below a fusing temperature in the case of fusion inhibiting print agents)? In some examples, the behavioural property is added to the color mapping resource. For example, this may be an indication that a threshold temperature was reached or not exceeded, or an indication of the temperature reached during processing. The temperature may for example be utilised to determine thermal maps for an object to be generated. It may be noted that such an object may have regions with different properties, e.g. different colors, and may therefore be printed using a plurality of different print instructions, and that that there may be heat exchange between two portions of the object. Moreover, object properties may be affected by the temperature of generation, which may for example impact the color, strength, density and the like of the object generated. By recording an indication of the temperature associated with the print instruction, print parameters may be tailored accordingly, thermal maps may be improved and/or trade-offs between, for example color and temperature may be made based on the information in the mapping resource.

In some examples, the mapping resource may be a resource mapping a color, for example specified in a device referred color space such as the sRGB color space, or a device independent color space such as CIELAB, CIEXYZ, or any color space specified by CIE or the like. The color may be a predicted color of the object or the method may comprise measuring the color from a test object.

In an example, the print instruction may be specified as a vector, for example specifying coverages/application amount of a set of agents comprising [C, M, Y, K, FA(CB), FA(LT), DA], where C is a cyan colorant, M is a magenta colorant, Y is yellow colorant, K is a (cosmetic) black colorant, FA(CB) is carbon black based fusing agent, FA(LT) is low tint fusing agent and DA is a detailing agent (i.e. a fusion inhibiting agent). This may map to a color, in this example in the sRGB color space.

In order to attain a particular color of fused build material, the amounts of the agents may be set. For example, a particular red defined by [R:255, G:0, B:0] may map to an additive manufacturing instructions of the form [C:0, M:40 ng, Y:50 ng, K:0, FA(CB):0, FA(LT):45 ng, DA:0] (i.e. agents should be applied to an intended red unit area in the amounts specified).

As may be noted, in this example, the coverage for at least one print agent in the additive manufacturing process instruction is zero.

The amounts of each thermal agent (FA(CB), FA(LT), DA) selected to be applied to attain for this color is dependent on the inherent thermal characteristics of the color agents included in the composition. For example, yellow ink may be thermally cooler than cyan or magenta, so colors heavy in Y may be associated with higher quantities of fusing agents. Conversely dark colors using black ink (K) are relatively efficient absorbers of incident energy, and may be associated less fusing agent in a print instruction. Use of dark colors may in some examples be associated with application of a cooling agent (DA) to prevent overheating. Such cooling agent may be printed on a region of build material which is to be fused (i.e. outside of its normal use, which is on regions of the build material which are to remain unfused, for example bordering a potion to be fused).

Moreover, the color of the low tint fusing agent (for example, a light cyan) may in effect be compensated for in selecting the colorants (or more generally the presence of the low tint fusing agent is taken into account in the mapping).

The print agents specified in the print instructions may comprise alternative or additional print agents. For example, additional colorants, such as grey, red, green, blue) or functional agents (or property modulating agents) such as conductive agents may be included, as well as other detailing agents and/or fusing agents.

The selection of the fusing agent may have an effect on the color: obtaining a particular color in combination with the carbon black fusing agent may result in a specification of different colorants than are specified for obtaining that color in combination with a low tint fusing agent. Some areas of the color gamut may be achievable with one fusing agent and not another. For example lighter regions of a color gamut may be associated with a selection of a low tint fusing agent and darker regions may be associated with a darker fusing agent, for example a black fusing agent. A color mapping resource may be configured to utilise a less expensive agent (e.g. a carbon black fusing agent in place of a low-tint fusing agent) where possible (for example, in relation to darker areas of the gamut, which may be accessible using either print agent). In some examples, a combination of fusing agents may be specified in a print instruction.

In an example in which thermal properties are added to the mapping resource, a print mapping resource may map between an intended target color and target temperature and a print instruction. For example, such a mapping may be of the form:

[R, G, B, T]: [C, M, Y, K, FA(CB), FA(LT), DA]

where T is an indication of temperature. In this way, there may be two (or more) combinations of print instructions which provide a particular color, but the print instruction which provides a particular intended temperature may be selected. In some examples, a temperature may be specified in object model data. In other examples, it may be determined as part of a print instruction determination pipeline, in which thermal considerations relating to other portions of the object and/or to object properties may be taken into account. For example, if a portion of an object would be at risk of failing to reach a fusing temperature, a print instruction which is associated with a higher temperature may be selected, whereas if a portion of an object is at risk of overheating, a print instruction which is associated with a lower temperature may be selected.

In other examples, the mapping may be, for example, between a color space and a print agent instruction comprising thermal behaviour information. For example, there may be a mapping between:

[R, G, B]: [C, M, Y, K, FA(CB), FA(LT), DA, T]. Such a mapping may be useful in determining a thermal model of the object to be generated.

In another example, there may be a mapping between

[R, G, B, T1]: [C, M, Y, K, FA(CB), FA(LT), DA, T2] where any difference between T1 and T2 may be taken into account during manufacture of the object and/or in selection of print instructions for at least one other portion of the object. In any of these examples, the color definition (e.g. choice of color space) and the choice of agents available may be modified, supplemented and/or substituted for alternative color definitions and/or agents.

In additive manufacturing, there may be trade-offs between the thermal absorption of a print agent and the heat applied: for example, the intensity or duration of irradiation of the layer may be tailored to a particular print agent/print agent combination in order to reach a threshold temperature during object manufacture. Therefore, for consistency, the temperature may not be recorded directly (as this is dependent on factors other than the combination of print agents), but may be recorded as a thermal absorption behaviour, or in an otherwise standardised format (for example, a particular radiation intensity and wavelength may be used as a standard, and temperatures normalised in relation thereto).

In some examples, the method of FIG. 1 may be carried out for a plurality of different additive manufacturing process instructions. This may comprise selecting or generating combinations of print agents for use as additive manufacturing instructions. In some examples, the coverage for print agents in a print instruction may be selected based on at least one of an anticipated color and an anticipated behaviour. For example, combinations of print agents which are expected to be well separated, or evenly separated, in colorimetry may be selected. In some examples, the combinations selected may be expected to result in colors at the extremes of the achievable color gamut (e.g. the brightest examples of a particular hue).

Additive manufacturing using a print instruction may comprise forming successive layers of build material. For example, the layer of build material may be formed of a granular material, such as a granular plastic material. The build material may be a powder, a liquid, a paste, or a gel. Examples of build material include semi-crystalline thermoplastic materials. The layer may for example be formed on a print bed, or on a previously formed and processed layer of build material. Print agent(s) may be applied using a print agent distributor, for example a print head which may dispense print agent using ‘inkjet’ techniques or the like, and which may for example move relative to the layer of print agent, and may perform at least one printing pass of the layer of build material. While the coverage of the print agents may be specified in some examples of print instructions as set out above, the actual locations to which a print agent is applied may be determined for example using a halftoning process or the like.

It may be intended to fuse a first portion of the layer, for example to form part of the object. To that end, the method may comprise applying a fusing agent to the first portion. For example, the fusing agent may comprise an agent with high energy absorptance (noting that absorptance is a measure of how well a material absorbs radiant energy), for example a carbon black-based print agent, or an alternative (for example a low-tint) fusing agent. However, where such an alternative fusing agent is a less efficient thermal absorber and/or more expensive (either in itself or in that more agent or energy may be applied to allow fusing temperatures to be reached), its use may be controlled, such that it is used in just those circumstances where it provides a particular benefit such as colorfulness.

In some examples, low tint fusing agents may be more efficient thermal absorbers than carbon black based fusing agents (but may be less readily available and/or more expensive). In general, limiting the application of fusing agent may increase an accessible color gamut. Thus, more efficient thermal absorbers may result in smaller amounts of fusing agent being applied (and thus potentially increasing colorfulness) while providing a broad accessible color gamut—which may be broader than if a higher amount of fusing agent is used.

In other examples, the colorant(s) themselves may be sufficiently efficient thermal absorbers to act as fusing agent. In some examples, fusing agent may be included in the print agent to be applied to build material for some target colors and not for others to achieve a print agent with an acceptable thermal absorptance.

A second portion of the layer of build material may be a portion which is not intended to form part of the object under generation. For example, the second portion may comprise a border region, for example adjacent to the portion of the layer to be solidified, either in the same layer or an adjacent layer. In some examples, a fusion inhibiting agent (and, in some examples, a color) may be applied to applied to the second portion.

Any colorant applied to the second portion in some examples may comprise a combination of colored agents that is different to the combination of colored agents in the colorant applied to the first portion of the layer of build material in block 104. In some examples, the colored agents may be taken from the same set of colored agents as may be applied to the first portion. For example, the same set of CMYK colorants may be applied to both portions, but the combination of colorants may differ between portions. This allows for a difference in color which may arise due to presence of fusing agent and/or fusion inhibiting agent in at least one of the first and second portions to be compensated for by altering the combination of colorants.

In some examples, an amount of fusion inhibiting agent may be determined based on an energy absorptance of the colorant applied to the second portion. For example, if a colorant with a relatively high energy absorptance is applied to the second portion, it means that the colorant at the second portion comparatively absorbs more thermal energy during a fusion process at the first portion than if the colorant has a relatively low energy absorptance. In order to reduce the likelihood of fusion occurring in the second portion, the effect of using a colorant with a relatively high energy can be offset by an increased amount of fusion inhibiting agent.

The amount of fusion inhibiting agent to be applied to the second portion of the layer of build material may also be determined based on other factors, such as an efficiency with which the fusing agent applied at the first portion absorbs radiation, the energy to be applied to the layer and/or a thermal profile across the first portion and the second portion of the layer of build material.

FIG. 2 is an example of an apparatus 200 comprising processing circuitry 202, the processing circuitry 202 comprising an interface 204 and a mapping module 206. In use of the apparatus 200, the interface 204 receives data representing a three-dimensional object, the data comprising an object color description and the mapping module 206 maps the object color description to an object generation instruction. To that end, the mapping module 206 comprises a mapping resource 208 associating a predetermined set of print agents with colors, the set of print agents comprising a fusing agent, a fusion reduction agent and a colorant, and wherein a mapping of the mapping resource 208 comprises a combination of a colorant and a fusing agent. The interface 204 may be an external interface, for example receiving data over a network, or an internal interface of the processing module, for example receiving data from a memory thereof. For example, the interface 204 may be an input/output interface of a processor.

The mapping resource 208 may be a mapping resource as generated by the method of FIG. 1. The mapping resource 208 may comprise a plurality of such mappings, for example associating specified colors (and in some examples, other properties) with print instructions.

The data representing a three-dimensional object may define a three-dimensional geometric model of at least a portion of the object to be generated in additive manufacturing, including the shape and extent of all or part of an object in a three-dimensional coordinate system, e.g. the solid portions of the object. The object model data may for example be generated by a computer aided design (CAD) application. The object color description may be provided a part of object property data. In one example, the object property data may comprise any or any combination of a target color, flexibility, elasticity, rigidity, surface roughness, porosity, density, conductivity and the like for at least a portion of the object to be generated. The object property data may define multiple object properties for a portion or portions of an object.

In some examples, the mapping resource 208 comprises a thermal behaviour associated with an object generation instruction, wherein the mapping module 206 is to map the object color description based in part on the thermal behaviour. In such examples, the mapping module 206 may map the object color description to provide a processing temperature meeting predetermined specifications in an object portion. The specification may for example be to provide a temperature which meets a threshold, or which falls within a range. In other examples, the temperature may be a temperature which allows an average temperature over at least a portion of the layer of build material to be obtained.

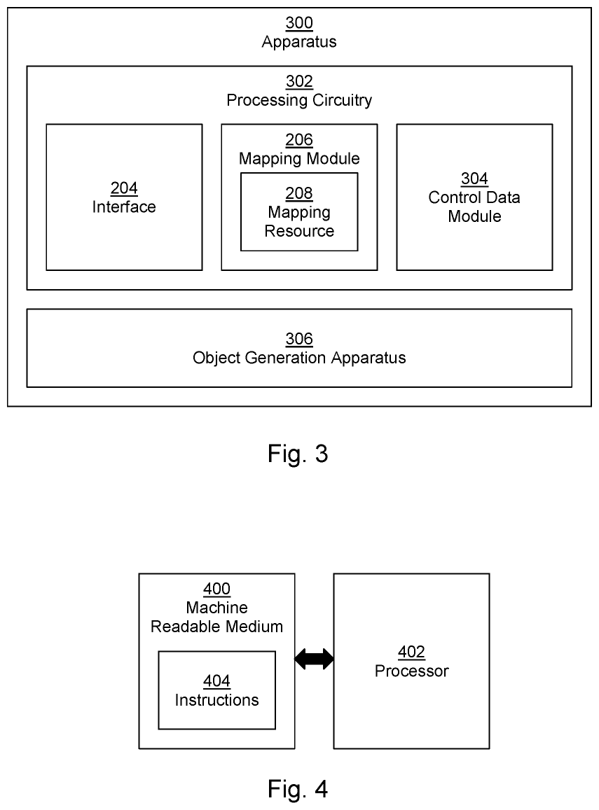

FIG. 3 shows an example of an apparatus 300 comprising processing circuitry 302 which comprises the interface 204 and the mapping module 206 having the mapping resource 208 as well as a control data module 304.

The apparatus 300 is associated with (and in some examples a component of) an object generation apparatus 306. The control data module 304, in use of the apparatus 300, generates control data to cause the object generation apparatus 306 to generate an object having, in at least a part thereof, an object color based on the object color description.

The object generation apparatus 306 comprises the set of print agents, for example stored in a plurality of print agent sources, and may generate the object according to the control data. To that end, the object generation apparatus 306 may comprise additional components such as a print bed, at least one build material applicator (for example a spreader or a roller or the like), print agent applicator(s) to selectively apply the print agents from the print agent sources according to the object generation instruction identified from the mapping resource, heat source(s), for example an infrared heat source and the like, not described in detail herein.

FIG. 4 is an example of a tangible, non-volatile, machine readable medium 400 in association with a processor 402. The machine readable medium 400 stores instructions 404 which, when executed by the processor 402, cause the processor 402 to carry out processes. The instructions 404 comprise instructions to, on receipt of data comprising a color description for an object to be generated in additive manufacturing, select an object generation instruction from a color mapping resource, wherein the color mapping resource associates a predetermined set of print agents with colors, the set of print agents comprising a fusing agent, a fusion reduction agent and a colorant, and wherein a first mapping of the color mapping resource comprises a combination of a colorant and a fusing agent. A second mapping may specify a fusion inhibiting agent. The mapping resource may for example comprise a mapping resource as generated in the method of FIG. 1, and the object generation instruction may comprise an additive manufacturing process instruction.

In some examples, a second mapping of the color mapping resource comprises a combination of a colorant and a fusing reduction agent.

The machine readable medium 400 may in some examples provide a module of the apparatus 200, 300.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that various blocks in the flow charts and block diagrams, as well as combinations thereof, can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (such as the interface 204, the mapping module 206 and the control data module 304) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining an additive manufacturing process instruction, the additive manufacturing process instruction comprising an instruction specifying a coverage of a set of print agents comprising a fusing agent and a colorant to be applied to build material;
determining a color and a behavioural property of carrying out an additive manufacturing process according to the additive manufacturing process instruction; and
in response to a determination that the behavioural property meets predetermined parameters, adding the instruction and the color to a color mapping resource.

2. A method according to claim 1 in which the set of print agents comprises at least one of:
a plurality of fusing agents associated with different behavioural properties and colorants associated with different colors; and
a fusion inhibiting agent.

3. A method according to claim 1 in which the behavioural property is a mechanical behaviour of fused build material obtained by carrying out the additive manufacturing process instruction and the method comprises determining that the behavioural property meets a predetermined threshold.

4. A method according to claim 1 in which the behaviour property is a thermal behaviour.

5. A method according to claim 4 further comprising adding the thermal behaviour to the color mapping resource.

6. A method according to claim 1 in which determining the color and the behavioural property comprises measuring the color and the behavioural property.

7. A method according to claim 1 wherein the coverage for at least one print agent in the additive manufacturing process instruction is zero.

8. A method according to claim 1 comprising carrying of the method for a plurality of different additive manufacturing process instructions.

9. A method according to claim 8 comprising selecting the coverage for print agents in a print instruction based on at least one of an anticipated color and an anticipated behaviour.

10. Apparatus comprising processing circuitry, the processing circuitry comprising:
an interface to receive data representing a three-dimensional object, the data comprising an object color description; and
a mapping module to map the object color description to an object generation instruction, wherein the mapping module comprises a mapping resource associating a predetermined set of print agents with colors, the set of print agents comprising a fusing agent, a fusion reduction agent and a colorant, and wherein a mapping of the mapping resource comprises a combination of a colorant and a fusing agent.

11. Apparatus according to claim 10 in which the mapping resource comprises a thermal behaviour associated with an object generation instruction, wherein the mapping module is to map the object color description based in part on the thermal behaviour.

12. Apparatus according to claim 11 in which the mapping module is to map the object color description to provide a processing temperature meeting predetermined specifications in an object portion.

13. Apparatus according to claim 10 further comprising a control data module, the control data module being to generate control data to cause an object generation apparatus to generate an object having, in at least a part thereof, an object color based on the object color description.

14. Apparatus according to claim 13 further comprising an object generation apparatus to generate the object according to the print instructions, the object generation apparatus comprising the set of print agents.

15. A tangible machine readable medium comprising instructions which, when executed by a processor, cause the processor to:
on receipt of data comprising a color description for an object to be generated in additive manufacturing, select an object generation instruction from a color mapping resource, wherein the color mapping resource associates a predetermined set of print agents with colors, the set of print agents comprising a fusing agent, a fusion reduction agent and a colorant, and wherein a first mapping of the color mapping resource comprises a combination of a colorant and a fusing agent.
